(19) United States
(12) Patent Application Publication
(10) Pub. No.: US 2009/0084348 A1
(43) Pub. Date: Apr. 2, 2009

(54) Method Of Accurately Metering A Gaseous Fuel That Is Injected Directly Into A Combustion Chamber Of An Internal Combustion Engine

(76) Inventors: Greg Batenburg, North Delta (CA); Richard Ancimer, Columbus, IN (US); Mark Edward Dunn, Vancouver (CA); Dale Goudie, Vancouver (CA)

Correspondence Address: MCANDREWS HELD & MALLOY, LTD, 500 WEST MADISON STREET, SUITE 3400, CHICAGO, IL, 60661, US

(21) Appl. No.: 12/208,044

(22) Filed: Sep. 10, 2008

Related U.S. Application Data
(63) Continuation of application No. PCT/CA2007/000249, filed on Feb. 19, 2007.

(30) Foreign Application Priority Data
Mar. 10, 2006 (CA) 2,538,984

(51) Int. Cl. F02B 43/00; F02B 3/00; F02D 41/30; F02B 47/08; F02M 25/07

(52) U.S. Cl. 123/294; 701/103; 123/568.11; 123/435

(57) ABSTRACT

For gaseous fuels that are injected directly into a combustion chamber the mass flow rate through an injection valve can be influenced by changes in the in-cylinder pressure. A method and apparatus are provided for accurately metering a gaseous into a combustion chamber of an internal combustion engine. The method comprises inputting a fueling command; determining from said fueling command a baseline pulse width of an injection event, based upon a baseline pressure differential across a fuel injection valve; estimating the difference between said baseline pressure differential and an actual pressure differential; calculating a corrected pulse width by applying at least one correction factor to said baseline pulse width, wherein said correction factor is a function of the estimated difference between said baseline pressure differential and said actual pressure differential.

### CROSS-REFERENCE TO RELATED APPLICATION(S)

This application is a continuation of International Application No. PCT/CA2007/000249, having an international filing date of Feb. 19, 2007, entitled “Method Of Accurately Metering A Gaseous Fuel That Is Injected Directly Into A Combustion Chamber Of An Internal Combustion Engine”. The '249 international application claimed priority benefits, in turn, from Canadian Patent Application No. 2,538,984 filed Mar. 10, 2006. The '249 international application is hereby incorporated by reference herein in its entirety.

### FIELD OF THE INVENTION

The present invention relates to a method of accurately metering a gaseous fuel that is injected directly into a combustion chamber of an internal combustion engine. More specifically, the invention relates to compensating for the pressure differential between the in-cylinder pressure and the fuel supply pressure, by adjusting fuel injection pulse width to accurately meter the desired quantity of fuel to the engine.

### BACKGROUND OF THE INVENTION

Engines that burn diesel fuel are the most common type of compression ignition engines. So-called diesel engines introduce liquid fuel at high pressure directly into the combustion chamber. Diesel engines are very efficient because this allows high compression ratios to be employed without the danger of knocking, which is the premature detonation of the fuel mixture inside the combustion chamber. Because diesel engines introduce their fuel directly into the combustion chamber, the fuel injection pressure must be greater than the pressure inside the combustion chamber when the fuel is being introduced. In a diesel engine, the peak in-cylinder pressure is typically less than 20 MPa (less than 3,000 psi) with many engines having a peak in-cylinder pressure less than 10 MPa (about 1,500 psi). For liquid fuels the pressure must be significantly higher so that the fuel is atomized for efficient combustion. A modern diesel engine can employ injection pressures of at least about 140 MPa (over 20,000 psi) with some engines employing diesel injection pressures as high as 220 MPa (about 32,000 psi). At injection pressures of these magnitudes the in-cylinder pressure has little impact on injector operation. That is, the injection pressure and the geometry of the fuel injection valve dictate the mass flow rate. In a conventional diesel engine, the pressure differential between the injection pressure and the in-cylinder pressure is so great that fluctuations in the in-cylinder pressure do not have a noticeable effect on the mass flow rate through the nozzle of the fuel injection valves. As long as the fuel injection pressure is substantially constant, when the valve is open the diesel mass flow rate is constant no matter what the in-cylinder pressure is.

Recent developments have been directed to substituting some of the diesel fuel with cleaner burning gaseous fuels such as, for example, natural gas, pure methane, butane, propane, hydrogen, and blends thereof. However, in this disclosure the term “gaseous fuel” is not limited to these examples. Gaseous fuel is defined herein as any combustible fuel that is in the gaseous phase at atmospheric pressure and ambient temperature. Since gaseous fuels are compressible fluids, it requires more energy to increase the pressure of a gaseous fuel to the same injection pressures that are employed to inject conventional liquid diesel fuels. However, unlike liquid fuels, gaseous fuels do not need to be atomized for improved combustion, so gaseous fuels need not be pressurized to the same high pressures. Gaseous fuels need only be pressurized to an injection pressure that is sufficient to overcome in-cylinder pressure at the time of the injection event and to introduce the desired amount of fuel within a desired time frame. For example, for a directly injected gaseous fuel, although higher pressures can be used, for some engines an injection pressure of about 18 MPa (about 2,600 psi) is high enough.

Accordingly, while it is possible to inject a gaseous fuel at the same injection pressure as a liquid fuel, overall efficiency can be improved by injecting gaseous fuels at a lower pressure and reducing the parasitic load that is associated with compressing the gaseous fuel to injection pressure. However, unlike the conventional diesel engines described above, at lower injection pressures, and since gaseous fuels are compressible fluids, the flow characteristics of gaseous fuels are different from those for liquid fuels. The effect of in-cylinder pressure on the mass flow rate of a compressible fluid through an injection valve depends upon whether the flow is choked or not. If the gaseous fuel flow is choked, then changes in the injection pressure will change the mass flow rate, but changes in the in-cylinder pressure will have no effect on the mass flow rate. At lower injection pressures, the pressure differential across the fuel injection valve is smaller and the injection valve can operate when the gaseous fuel is not choked, and under such conditions, in-cylinder pressure has a significant effect on the pressure differential across the fuel injection valve and so in-cylinder pressure can influence mass flow rate through the fuel injection valve. Accordingly, while the fuel injection pressure can be the more important factor in influencing gaseous fuel mass flow rates, when fuel flow is not choked the operation of the injector can also be influenced by in-cylinder pressure. That is, with the disclosed gaseous-fuelled engine, for a given injection pulse width, mass flow rate can change if there is a change in the in-cylinder pressure.

In addition, depending upon the actuation mechanism for the fuel injection valve, the lower pressure differential across the fuel injection valve (compared to the pressure differential across a typical diesel fuel injection valve), can also influence the fueling rate because changes in the in-cylinder pressure can change how quickly the valve needle opens or the equilibrium position of the valve needle when it is open. For example, with typical designs for inward opening needles, fuel inside the fuel injection valve can act on a shoulder of the needle to provide a portion of the opening force. In a diesel fuel injection valve, since the pressure of the diesel fuel is so much greater than the in-cylinder pressure, changes the in-cylinder pressure have no noticeable effect on the speed at which the valve needle moves from the closed to open positions. However, with a fuel injection valve for a gaseous fuel that is introduced at a lower fuel injection pressure, changes in the in-cylinder pressure can influence the speed at which the valve needle moves from the closed to open position. For a gaseous fuel injection valve higher in-cylinder pressures can increase the valve opening speed, which can result in a higher fuel mass flow rate for a given injection pulse width.

In a gaseous-fueled direct injection engine the pressure differential across the fuel injection valve is variable and since the in-cylinder pressure can range from a very low pressure at the beginning of a compression stroke to peak cylinder pressure, depending upon the timing for the start of injection there can be times when the fuel flow through the injection valve is choked and other times when fuel flow is not choked.

Accordingly, there is a need to control the fuel injection system to account for the effects of the pressure differential between the injection pressure and the in-cylinder pressure so that the desired amount of gaseous fuel is accurately metered into the engine's combustion chambers. The problem addressed herein, that is associated with direct injection gaseous-fueled engines, is believed to be a new problem that is not addressed by any prior art, especially since in-cylinder pressure has no significant influence on the mass flow rate of liquid fuel that injected into the combustion chamber of known diesel engines.

### SUMMARY OF THE INVENTION

A method is provided for accurately metering a fuel that is injected directly into a combustion chamber of an internal combustion engine. The method comprises:
(a) inputting a fueling command;
(b) determining from the fueling command a baseline pulse width of an injection event, based upon a baseline pressure differential across a fuel injection valve;
(c) estimating the difference between the baseline pressure differential and an actual pressure differential; and
(d) calculating a corrected pulse width by applying at least one correction factor to the baseline pulse width, wherein the correction factor is a function of the estimated difference between the baseline pressure differential and the actual pressure differential.

In a preferred method, the step of estimating the difference between the baseline pressure differential and the actual pressure differential comprises measuring fuel rail pressure and determining a fuel rail pressure correction factor based upon the difference between measured fuel rail pressure and a baseline fuel rail pressure that is assumed in the baseline pressure differential; and estimating instantaneous in-cylinder pressure and determining an in-cylinder pressure correction factor based upon the difference between estimated instantaneous in-cylinder pressure and a baseline in-cylinder pressure that is assumed in the baseline pressure differential.

In some embodiments the instantaneous in-cylinder pressure can be estimated from inputs comprising a commanded timing for start of injection and intake manifold pressure. In other embodiments the instantaneous in-cylinder pressure can be estimated from inputs comprising a commanded timing for start of injection and a measured mass charge flow.

The step of estimating the difference between the baseline pressure differential and the actual pressure differential can comprise: measuring fuel rail pressure; commanding a timing for start of injection; estimating actual in-cylinder pressure from measured engine parameters; estimating the actual pressure differential by subtracting the estimated actual in-cylinder pressure from the measured fuel rail pressure; and subtracting the baseline pressure differential from the estimated actual pressure differential.

In calculating an estimated instantaneous in-cylinder pressure, the method can estimate an actual timing for start of injection from an input value for the commanded timing for start of injection. That is, the method can comprise estimating the actual timing for start of injection by correcting for time delays associated with the injector driver response time and time delays in mechanically transmitting actuation from an actuator to a valve member of a fuel injection valve. Once the actual timing for start of injection is estimated, a better estimate of the instantaneous in-cylinder pressure can be made as a function of the estimated actual timing for start of injection. If the valve member of the fuel injection valve is hydraulically actuated and the time delays in mechanically transmitting actuation of the valve member can comprise a hydraulic response time delay.

In another embodiment of the method the instantaneous in-cylinder pressure can be estimated from inputs comprising at least one of volumetric efficiency, measured pressure inside an intake manifold, measured temperature inside an intake manifold, ambient air temperature, cylinder bore diameter, piston stroke length, and exhaust gas recirculation flow rate. Instead of measuring mass charge flow or in-cylinder pressure directly, at least one of these parameters can be calculated from inputs of these or other measured parameters.

In yet another embodiment of the method, the difference between the baseline pressure differential and the actual pressure differential is estimated by referring to a look-up table of empirically established values as a function of: at least one of volumetric efficiency, measured pressure inside an intake manifold, measured temperature inside the intake manifold, ambient air temperature, cylinder bore diameter, piston stroke length, and exhaust gas recirculation flow rate; and, measured fuel rail pressure.

The method can further comprise calculating combustion pressure rise, determining a combustion rise correction factor, and applying the combustion rise correction factor to the baseline injection pulse width as part of the calculation of the corrected injection pressure pulse width.

Instead of calculating the in-cylinder pressure, the estimated actual in-cylinder pressure can be determined from a look-up table as a function of the measured engine parameters.

Instead of calculating one correction factor for the injection pressure and another correction factor for the in-cylinder pressure, one correction factor can be determined for the difference between the estimated pressure differential and a baseline pressure differential across the fuel injection valve. For example, the step of estimating the difference between the baseline pressure differential and the actual pressure differential can comprise: measuring fuel rail pressure; commanding a timing for start of injection; measuring instantaneous in-cylinder pressure; estimating the actual pressure differential by subtracting the measured instantaneous in-cylinder pressure from the measured fuel rail pressure; and, subtracting the baseline pressure differential from the estimated actual pressure differential.

To practice the method, an apparatus is provided for accurately metering a gaseous fuel that is injectable directly into a combustion chamber of an internal combustion engine. The apparatus comprises:
(a) a fuel injection valve with a nozzle disposed in the combustion chamber and an actuator operative to open and close the fuel injection valve;
(b) a pressure sensor associated with a fuel supply line for measuring injection pressure;
(c) at least one sensor associated with the engine for measuring an engine parameter from which an estimated in-cylinder pressure can be determined;
(d) an electronic controller programmable to: calculate an estimated pressure differential by subtracting the estimated in-cylinder pressure from the measured injection pressure; determine a baseline fuel injection pulse width from a fueling command; and, correct the baseline pulse width if there is a difference between a predetermined baseline pressure differential that is associated with the baseline fuel injection pulse width and the estimated pressure differential.

In one preferred embodiment the at least one sensor associated with the engine for measuring an engine parameter is a mass flow rate sensor mounted in an intake air manifold of the engine and the electronic controller is programmable to calculate the estimated in-cylinder pressure from measurements of charge mass flow rate. In another preferred embodiment a plurality of sensors are associated with the engine for measuring intake charge temperature and intake charge pressure and the electronic controller is programmable to calculate the estimated in-cylinder pressure from measurements of intake charge temperature and intake charge pressure.

The apparatus can further comprise a conduit for recirculating exhaust gas from an engine exhaust pipe to an engine intake air manifold, a valve for controlling flow rate through the conduit and wherein one of the plurality of sensors is a sensor for determining exhaust gas re-circulation flow rate and the electronic controller is programmable to account for the determined exhaust gas re-circulation flow rate in calculating the estimated in-cylinder pressure. To measure the mass flow rate through the conduit the apparatus can further comprise a first pressure sensor disposed in the conduit for recirculating exhaust gas and a second pressure sensor disposed in a venturi restriction disposed in the conduit, wherein the electronic controller is programmable to determine exhaust gas recirculation flow rate by determining a differential between pressure measurements by the first and second pressure sensors.

In another embodiment, the at least one sensor associated with the engine for measuring an engine parameter is a sensor with a sensing element disposed within the combustion chamber for measuring in-cylinder pressure. The other methods of determining in-cylinder pressure are preferred because, while sensors exist for measuring in-cylinder pressure directly, such instruments are much more expensive than the sensors that can be used to measure other parameters from which in-cylinder pressure can be estimated. However, future developments in instrumentation could make direct measurement of in-cylinder pressure more affordable.

The electronic controller can be programmed to reference look-up tables to access pre-calculated or empirically developed values for determining the baseline pulse width and correcting it. For example, the apparatus can comprise a look-up table referenceable by the electronic controller for determining a baseline injection pulse width from a fueling command. The apparatus can further comprise a look-up table referenceable by the electronic controller for estimating in-cylinder pressure from a measured charge mass flow rate or from a measured intake charge pressure and a measured intake charge temperature.

### BRIEF DESCRIPTION OF THE DRAWINGS

FIG. 1 is a flow diagram that illustrates a method of correcting gaseous fuel injection pulse width by determining an in-cylinder pressure correction factor from inputs comprising the timing for start of injection and the intake manifold pressure. The method also determines a rail pressure correction factor based upon the difference between a measured fuel rail pressure and a baseline fuel rail pressure.

FIG. 2 is a flow diagram that illustrates a method that is similar to that of FIG. 1 except that instead of measuring the intake manifold pressure to calculate the in-cylinder pressure correction factor, a sensor is used to measure the mass charge flow in the intake air manifold.

FIG. 3 is a flow diagram that illustrates a method that is different from FIG. 1 in that the in-cylinder pressure correction factor is determined by calculating the actual timing for start of injection and calculating mass charge flow or in-cylinder pressure instead of using a sensor to measure mass charge flow directly.

FIG. 4 is a flow diagram that illustrates a method that is like the method of FIG. 3 with the additional steps of calculating combustion pressure rise and determining a combustion rise correction factor which is employed in the calculation of the corrected injection pulse width.

FIG. 5 is a flow diagram that illustrates a method that is different from the method of FIG. 1 in that instead of calculating an in-cylinder pressure correction factor and a rail pressure correction factor, in the method of FIG. 5 the actual pressure differential is calculated to determine a pressure differential correction factor.

FIG. 6 is a schematic view of an apparatus for practicing the disclosed method. The apparatus comprises a fuel supply system, a fuel injection valve for injecting the fuel directly into a combustion chamber of an internal combustion engine, an electronic controller and sensors for determining fuel injection pressure and instantaneous in-cylinder pressure.

### DETAILED DESCRIPTION OF PREFERRED EMBODIMENT(S)

The pressure differential across the fuel injection valve is dependent upon the injection pressure and the in-cylinder pressure. In a common rail fuel injection system, the injection pressure of the gaseous fuel is the pressure of the fuel in the fuel rail, and in some engines the fuel injection pressure is variable as a function of engine operating conditions. The in-cylinder pressure is the instantaneous pressure in the combustion chamber when the fuel is being injected therein. In-cylinder pressure is dependent upon several factors. For example, the mass charge being compressed in the cylinder, which itself depends upon intake manifold air pressure, charge temperature, the volumetric efficiency of the engine at the current engine speed, the bore and stroke of the engine, and if the engine employs exhaust gas recirculation, the amount of exhaust gas that is currently being recirculated. Since the in-cylinder pressure changes throughout the engine cycle, the time at which the injection event begins also influences the pressure differential. The actual time that an injection event begins is dependent on the commanded start of injection, the injector driver response time, and the responsiveness of the injection valve to the command to start injecting fuel. For example, if the injection valve is hydraulically actuated, there may be a hydraulic delay. The instantaneous in-cylinder pressure increases as a result of energy released during the engine cycle and if fuel is still being injected after combustion begins, the combustion pressure rise can influence the differential pressure. In preferred embodiments, the control strategy for the direct injection of gaseous fuel compensates by adjusting the pulse width of the injection event for all of these factors.

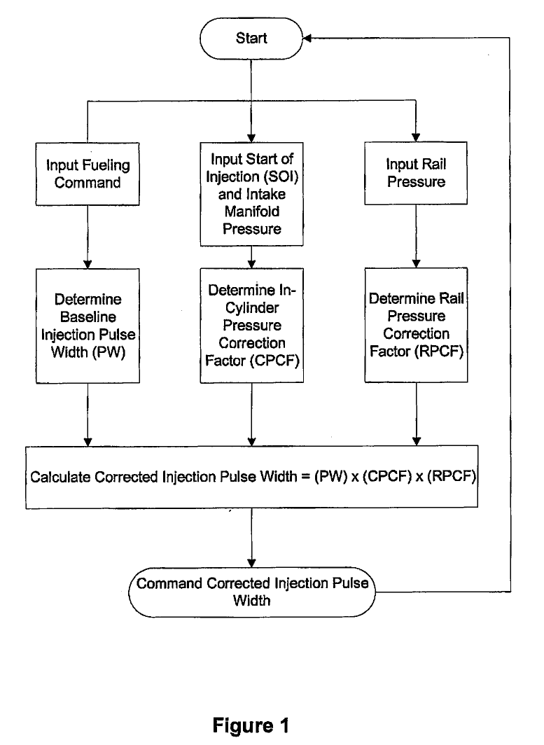

FIG. 1 is a flow diagram that illustrates a control strategy for compensating for changes in the pressure differential across the fuel injection valve for improved fuel metering accuracy. According to the disclosed control strategy, a number of variables are input into the controller, and from these variables an electronic controller can calculate a corrected injection pulse width. In the method illustrated by FIG. 1, from an inputted fueling command, the electronic controller determines a baseline injection pulse width (PW). The pulse width is the duration of an injection event. The baseline injection pulse width is a predetermined injection pulse width based upon a presumed baseline pressure differential across the fuel injection valve. If the actual in-cylinder pressure is different from the in-cylinder pressure that is presumed by the baseline injection pulse width, then an in-cylinder pressure correction factor (CPCF) is applied. As shown by FIG. 1, the electronic controller can determine the in-cylinder pressure correction factor from inputs including the timing for start of injection and the intake manifold pressure. With these inputs the electronic controller can refer to a look-up table to determine the in-cylinder pressure correction factor. The method also uses inputs of the actual fuel injection pressure to determine a rail pressure correction factor (RPCF) if the actual injection pressure is different from the presumed baseline injection pressure. The electronic controller calculates the corrected injection pulse width by taking the baseline injection pulse width and multiplying it by the in-cylinder pressure correction factor and by the rail pressure correction factor. The electronic controller then commands the corrected injection pulse width to the fuel injection valve.

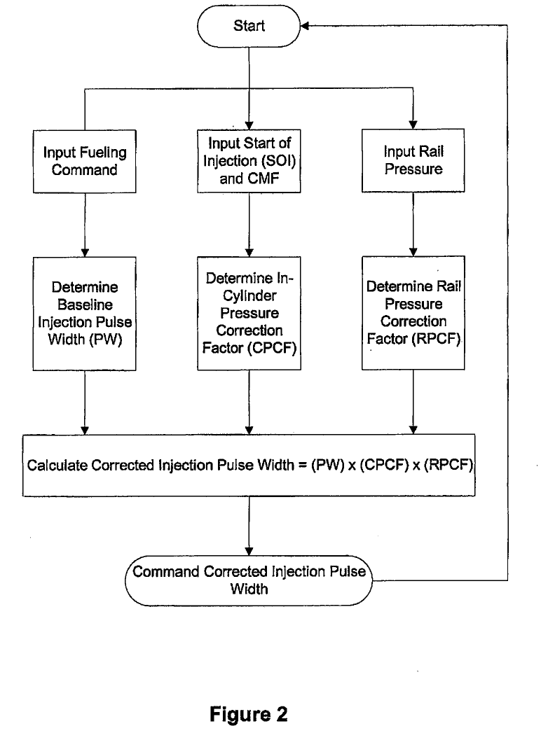

FIG. 2 illustrates a method that is the same as the method of FIG. 1 except that instead of determining an in-cylinder pressure correction factor from the timing for the start of injection and the intake manifold pressure, the method of FIG. 2 substitutes charge mass flow rate instead of intake manifold pressure. That is, according to the method shown by FIG. 2, the in-cylinder pressure correction factor is determined from the timing for start of injection and the charge mass flow rate into the engine's combustion chamber.

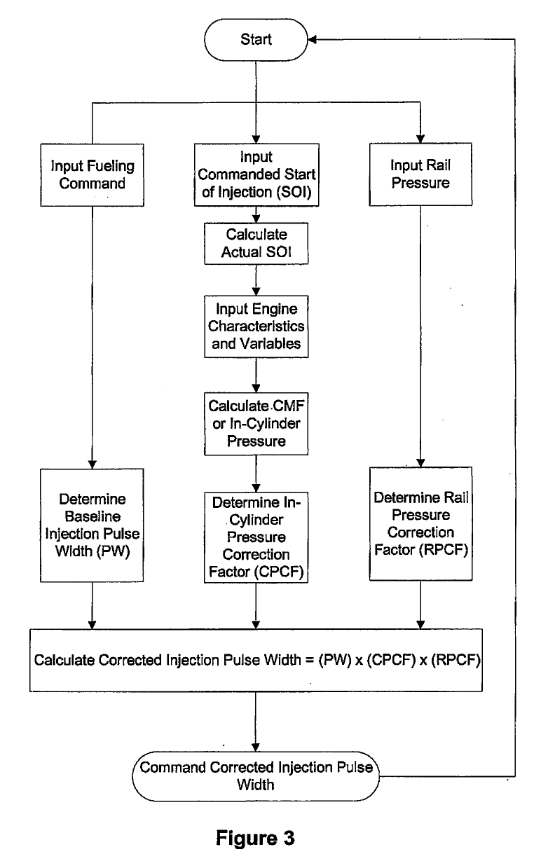

The method shown in FIG. 3 determines the baseline injection pulse width (PW) and the rail pressure correction factor (RPCF) in the same manner as in the methods illustrated by FIGS. 1 and 2. The difference with the method of FIG. 3 is in the determination of the in-cylinder pressure correction factor. One difference is that in this method the actual timing for the start of injection is calculated from an input of the commanded timing for start of injection. The calculation of the actual timing for start of injection by compensates for delays caused by the response time of the driver for the fuel injection valve and for hydraulic delays if the fuel injection valve is hydraulically driven. Since the fuel is normally injected during the compression stroke the in-cylinder pressure is always increasing so even a short delay between the commanded timing for start of injection and the actual timing for start of injection can be significant in determining the actual in-cylinder pressure. Another difference with the method of FIG. 3 is that instead of being measured, the charge mass flow rate is calculated from engine characteristics and variables that are input into the electronic controller. For example, the engine characteristics can include piston bore diameter, piston stroke, and the engine's volumetric efficiency as a function of engine speed. The variables can include, for example, intake charge pressure and intake charge temperature, and exhaust gas recirculation flow rate. An advantage of this method over the method of FIG. 2 is that since charge mass flow rate is calculated, there is no need for instrumentation to measure charge mass flow rate, and this can reduce the cost of the system. The variables that are measured and used to calculate charge mass flow rate can be easier and less expensive to measure compared to measuring charge mass flow rate directly, and some of the parameters that can be measured to calculate charge mass flow rate can also be used for other engine control functions.

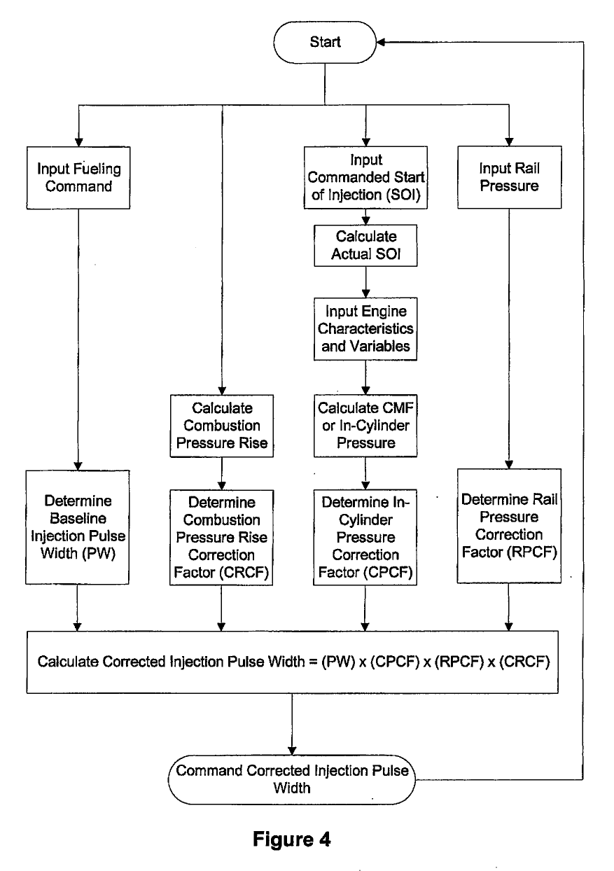

The method shown in FIG. 4 is the same as the method shown in FIG. 3 with the additional step of calculating combustion pressure rise and application of a determined combustion pressure rise correction factor. The increase in the in-cylinder pressure caused by the combustion of the fuel inside the combustion chamber can have a significant effect on the flow through the fuel injection valve by sharply reducing the pressure differential across the fuel injection valve and by influencing the force balance in the injection valve. This effect does not occur under all operating conditions but is more likely to occur under higher engine load conditions when more fuel is being introduced into the combustion chamber, requiring longer injection pulse widths. Under such conditions there can be times when fuel is still being introduced when combustion begins. The effect of combustion pressure rise can also be a factor if the engine employs a plurality of fuel injection pulses in some engine cycles, and a fuel injection pulse commanded late in the engine cycle can be timed to occur after combustion has started.

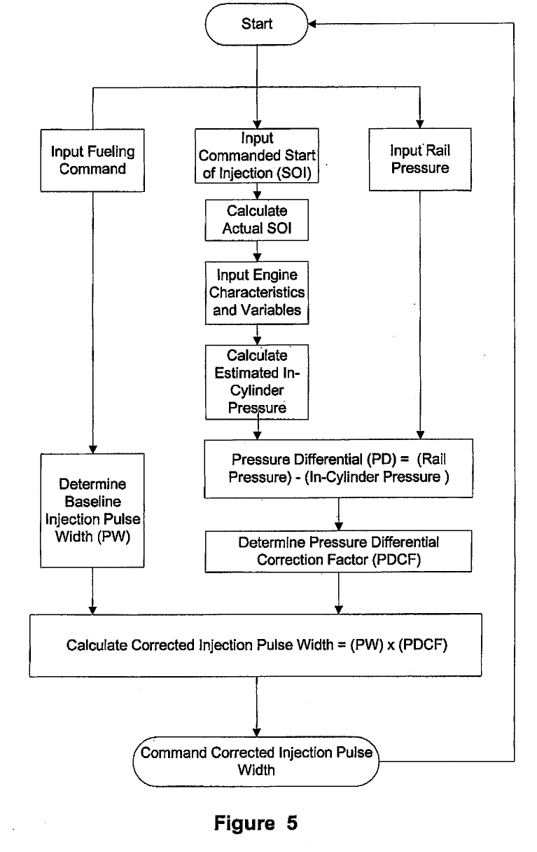

The method illustrated by FIG. 5 is different from the other methods in that the method of FIG. 5 calculates the pressure differential (PD) across the fuel injection valve and applies one correction factor for the difference between a baseline pressure differential and the estimated actual pressure differential. In the illustrated embodiment of this method the commanded timing for start of injection is corrected by calculating the actual timing for start of injection by compensating for fuel injection valve driver response time and hydraulic time delays, if the fuel injection valve is hydraulically actuated. The method calculates an estimated in-cylinder pressure from engine characteristics and variables like in the methods depicted in FIGS. 3 and 4. The pressure differential (PD) is then calculated by subtracting the calculated estimate of in-cylinder pressure and subtracting it from the rail pressure, which can be measured by a pressure sensor associated with the fuel rail. Like in all of the other methods, a baseline injection pulse width (PW) is determined from an inputted fueling command based upon a presumed baseline pressure differential. The method of FIG. 5 determines a pressure differential correction factor (PDCF) based upon the difference between the presumed baseline pressure differential and the calculated pressure differential. Next the electronic controller is programmed to calculate a corrected injection pulse width by multiplying the baseline injection pulse width by the pressure differential correction factor.

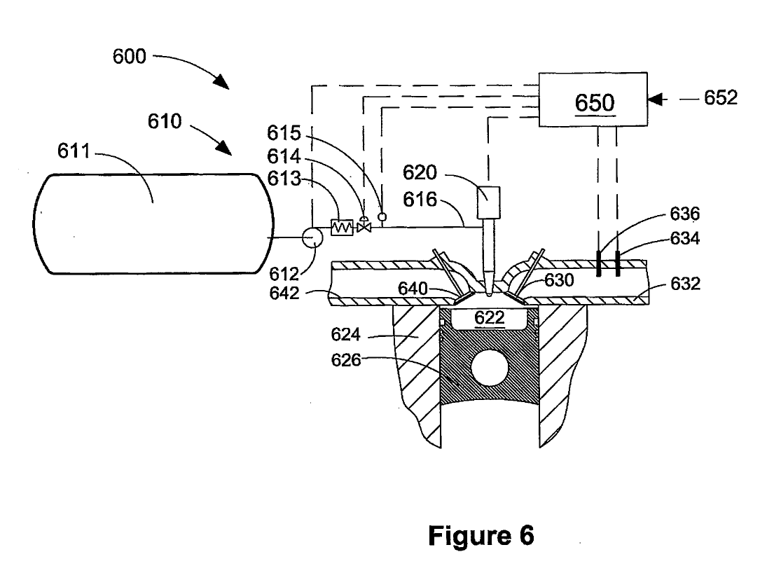

FIG. 6 is a schematic view of apparatus 600 which can be employed to practice the disclosed method. In overview, apparatus 600 comprises fuel supply system 610, fuel injection valve 620 for injecting fuel directly into combustion chamber 612 of an internal combustion engine, electronic controller 650, and sensors for determining fuel injection pressure and instantaneous in-cylinder pressure.

Fuel supply system 610 comprises fuel storage vessel 611, compressor 612, heat exchanger 613 and pressure sensor 615. In the illustrated embodiment fuel storage vessel 611 is shown as a pressure vessel that can hold compressed gas at high pressure. Such storage vessels are rated for holding gases up to a specified pressure, and in preferred embodiments the storage vessel is rated for at least 31 MPa (about 4,500 psi), but, depending upon limits that can be set by local regulations, vessels with higher pressure ratings can be used to store the fuel at a higher pressure with increased energy density. Heat exchanger 613 cools the fuel after it has been compressed. Pressure sensor 615 is located along fuel supply rail 615 and measures fuel pressure therein, with these pressure measurements inputted into electronic controller 650. The apparatus can be employed by a multi-cylinder engine with fuel supply rail 616 delivering fuel to a plurality of fuel injection valves, but to simplify the illustration of the apparatus, only one fuel injection valve and one combustion chamber is shown.

In other embodiments, the storage vessel can be thermally insulated for storing the fuel as a liquefied gas, with even higher storage densities. In such embodiments, instead of compressor 612, the apparatus preferably comprises a pump for pumping the cryogenic fluid before it is vaporized, since it is more efficient to pump the fuel as a liquefied gas compared to compressing the same fuel with a compressor after it is vaporized.

Fuel injection valve 620 injects the fuel directly into combustion chamber 622, which is defined by cylinder 624, piston 624 and the cylinder head. Intake valve 630 is operable to open during the intake strokes to allow an intake charge to be induced into combustion chamber 622. Intake valve 630 is otherwise closed. The intake charge flows through intake manifold 632 on its way to combustion chamber 622. The illustrated embodiment comprises pressure sensor 634 and temperature sensor 636, each disposed in intake manifold 632 for respectively measuring pressure and temperature of the intake charge, which can comprise air only, or air and recirculated exhaust gas if the engine is equipped with an exhaust gas recirculation system (not shown). Pressure sensor 634 and temperature sensor 636 each send respective signals to electronic controller 650 which can be programmed to process the measured parameters to estimate in-cylinder pressure.

Exhaust valve 640 is opened during engine exhaust strokes to expel exhaust gases from combustion chamber 622 when piston 626 is moving towards top dead center after the completion of a power stroke. Exhaust gas is carried away by exhaust manifold 642. While not shown in FIG. 6, the engine can further comprise an exhaust gas recirculation system for recirculating a portion of the exhaust gas back to the intake manifold for re-introduction into combustion chamber 622. If the apparatus comprises an exhaust recirculation system, it can further comprise sensors for measuring the exhaust gas recirculation mass flow rate.

As shown in FIG. 6 by dashed signal lines, electronic controller 650 communicates with a number of components to receive measured engine parameters from sensors and to send signals to actuators for engine components for controlling their operation. Electronic controller 650 is programmable to calculate an estimated pressure differential by subtracting estimated in-cylinder pressure from said measured injection pressure. Injection pressure is measured by pressure sensor 615, and in-cylinder pressure can be measured directly or calculated from measured parameters such intake charge pressure and intake charge temperature, measured by pressure sensor 634 and temperature sensor 636. Other embodiments can employ instrumentation for measuring the charge mass flow rate, and the electronic controller in such embodiments can be programmed to calculate in-cylinder pressure from the charge mass flow rate.

Electronic controller 650 also receives other inputs 652, which can comprise, for example, a fueling command and current engine speed. When in-cylinder pressure is not measured directly, the calculations made by electronic controller 650 incorporate other known parameters to calculate in-cylinder pressure, such as the cylinder bore diameter, the length of each piston stroke, and the volumetric efficiency, which can be retrieved from a look-up table as a function of engine speed. That is, the formulas programmed into electronic controller 650 to calculate in-cylinder pressure use such known parameters to execute the programmed calculations. In other embodiments, instead of calculating in-cylinder pressure, electronic controller 650 can be programmed to retrieve an estimated in-cylinder pressure from an empirically derived look up table, which determines in-cylinder pressure as a function of certain measured parameters. For example, in a two dimensional table, for a measured intake charge pressure and a measured intake charge temperature, the electronic controller can retrieve an estimated in-cylinder pressure from the look-up table.

Electronic controller 650 can also be programmed to determine a baseline fuel injection pulse width from an inputted fueling command. For example, electronic controller 650 can determine the baseline fuel injection pulse width be referencing a look-up table with predetermined fuel injection pulse widths for specific fueling commands. The baseline fuel injection pulse width is based upon a predetermined baseline pressure differential across the fuel injection valve. However, since the flow through the fuel injection valve may not be choked, electronic controller 650 is programmed to correct the baseline fuel injection pulse width if there is a difference between a predetermined baseline pressure differential and the estimated pressure differential, which electronic controller 650 calculates from the measured fuel rail pressure and the estimated in-cylinder pressure.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A method of accurately metering a gaseous fuel that is injected directly into a combustion chamber of an internal combustion engine, said method comprises:
(a) inputting a fueling command;
(b) determining from said fueling command a baseline pulse width of an injection event, based upon a baseline pressure differential across a fuel injection valve;
(c) estimating the difference between said baseline pressure differential and an actual pressure differential;
(d) calculating a corrected pulse width by applying at least one correction factor to said baseline pulse width, wherein said correction factor is a function of the estimated difference between said baseline pressure differential and said actual pressure differential.

2. The method of claim 1 wherein said step of estimating the difference between said baseline pressure differential and said actual pressure differential comprises:
measuring fuel rail pressure and determining a fuel rail pressure correction factor based upon the difference between measured fuel rail pressure and a baseline fuel rail pressure that is assumed in said baseline pressure differential; and
estimating instantaneous in-cylinder pressure and determining an in-cylinder pressure correction factor based upon the difference between estimated instantaneous in-cylinder pressure and a baseline in-cylinder pressure that is assumed in said baseline pressure differential.

3. The method of claim 2 wherein said instantaneous in-cylinder pressure is estimated from inputs comprising a commanded timing for start of injection and intake manifold pressure.

4. The method of claim 2 wherein said instantaneous in-cylinder pressure is estimated from inputs comprising a commanded timing for start of injection and a measured mass charge flow.

5. The method of claim 2 wherein said instantaneous in-cylinder pressure is estimated from inputs comprising a commanded timing for start of injection, and said method further comprises estimating an actual timing for start of injection by correcting for injector driver response time and time delays in mechanically transmitting actuation from an actuator to a valve member of a fuel injection valve, and estimating said instantaneous in-cylinder pressure as a function of said estimated actual timing for start of injection.

6. The method of claim 5 wherein said valve member is hydraulically actuated and said time delays in mechanically transmitting actuation of said valve member comprise a hydraulic response time delay.

7. The method of claim 2 wherein said instantaneous in-cylinder pressure is estimated from inputs comprising at least one of volumetric efficiency, measured pressure inside an intake manifold, measured temperature inside an intake manifold, ambient air temperature, cylinder bore diameter, piston stroke length, and exhaust gas recirculation flow rate.

8. The method of claim 7 further comprising calculating mass charge flow or in-cylinder pressure from said inputs.

9. The method of claim 1 wherein said difference between said baseline pressure differential and said actual pressure differential is estimated by referring to a look-up table of empirically established values as a function of:
at least one of volumetric efficiency, measured pressure inside an intake manifold, measured temperature inside said intake manifold, ambient air temperature, cylinder bore diameter, piston stroke length, and exhaust gas recirculation flow rate; and
measured fuel rail pressure.

10. The method of claim 1 further comprising calculating combustion pressure rise, determining a combustion rise correction factor, and applying said combustion rise correction factor to said baseline injection pulse width as part of the calculation of said corrected injection pressure pulse width.

11. The method of claim 1 wherein said step of estimating the difference between said baseline pressure differential and said actual pressure differential comprises:
measuring fuel rail pressure;
commanding a timing for start of injection;
estimating actual in-cylinder pressure from measured engine parameters;
estimating said actual pressure differential by subtracting said estimated actual in-cylinder pressure from said measured fuel rail pressure; and
subtracting said baseline pressure differential from said estimated actual pressure differential.

12. The method of claim 11 further comprising estimating an actual timing for start of injection from said commanded timing for start of injection by correcting for delays in response time between commanded timing and actual timing.

13. The method of claim 11 wherein said measured engine parameters that are employed to estimate actual in-cylinder pressure comprise at least one of intake manifold charge pressure, intake manifold charge temperature, charge mass flow rate, and exhaust gas recirculation flow rate.

14. The method of claim 13 wherein said charge mass flow rate is not one of said measured engine parameters, and charge mass flow rate is estimated from said measured parameters.

15. The method of claim 13 wherein engine characteristics comprising volumetric efficiency, bore diameter, and piston stroke are employed to calculate said estimated actual in-cylinder pressure.

16. The method of claim 13 wherein said estimated actual in-cylinder pressure is determined from a look-up table as a function of said measured engine parameters.

17. The method of claim 1 wherein said step of estimating the difference between said baseline pressure differential and said actual pressure differential comprises:
measuring fuel rail pressure; commanding a timing for start of injection;
measuring instantaneous in-cylinder pressure; estimating said actual pressure differential by subtracting said measured instantaneous in-cylinder pressure from said measured fuel rail pressure; and
subtracting said baseline pressure differential from said estimated actual pressure differential.

18. An apparatus for accurately metering a gaseous fuel that is injectable directly into a combustion chamber of an internal combustion engine, said apparatus comprising:
(a) a fuel injection valve with a nozzle disposed in said combustion chamber and an actuator operative to open and close said fuel injection valve;
(b) a pressure sensor associated with a fuel supply line for measuring injection pressure;
(c) at least one sensor associated with said engine for measuring an engine parameter from which an estimated in-cylinder pressure can be determined;
(d) an electronic controller programmable to:
calculate an estimated pressure differential by subtracting said estimated in-cylinder pressure from said measured injection pressure;
determine a baseline fuel injection pulse width from a fueling command; and
correct said baseline pulse width if there is a difference between a predetermined baseline pressure differential that is associated with said baseline fuel injection pulse width and said estimated pressure differential.

19. The apparatus of claim 18 wherein said at least one sensor associated with said engine for measuring an engine parameter is a mass flow rate sensor mounted in an intake air manifold of said engine and said electronic controller is programmable to calculate said estimated in-cylinder pressure from measurements of charge mass flow rate.

20. The apparatus of claim 18 wherein a plurality of sensors are associated with said engine for measuring intake charge temperature and intake charge pressure and said electronic controller is programmable to calculate said estimated in-cylinder pressure from measurements of intake charge temperature and intake charge pressure.

21. The apparatus of claim 20 further comprising a conduit for recirculating exhaust gas from an engine exhaust pipe to an engine intake air manifold, a valve for controlling flow rate through said conduit and wherein one of said plurality of sensors is a sensor for determining exhaust gas re-circulation flow rate and said electronic controller is programmable to account for said determined exhaust gas re-circulation flow rate in calculating said estimated in-cylinder pressure.

22. The apparatus of claim 21 further comprising a first pressure sensor disposed in said conduit for recirculating exhaust gas and a second pressure sensor disposed in a venturi restriction disposed in said conduit, wherein said electronic controller is programmable to determine exhaust gas recirculation flow rate by determining a differential between pressure measurements by said first and second pressure sensors.

23. The apparatus of claim 18 wherein said at least one sensor associated with said engine for measuring an engine parameter is a sensor with a sensing element disposed within said combustion chamber for measuring in-cylinder pressure.

24. The apparatus of claim 18 further comprising a look-up table referenceable by said electronic controller for determining a baseline injection pulse width from a fueling command.

25. The apparatus of claim 18 further comprising a look-up table referenceable by said electronic controller for estimating in-cylinder pressure from a measured charge mass flow rate.

26. The apparatus of claim 18 further comprising a look-up table referenceable by said electronic controller for estimating in-cylinder pressure from a measured intake charge pressure and a measured intake charge temperature.
